(19) United States
(12) Patent Application Publication
(10) Pub. No.: US 2023/0056753 A1
(43) Pub. Date: Feb. 23, 2023

(54) ROLL-TYPE PIZZA AND METHOD OF MAKING THE SAME

(71) Applicant: Eric Frakes, Vacaville, CA (US)

(72) Inventor: Eric Frakes, Vacaville, CA (US)

(21) Appl. No.: 17/404,180

(22) Filed: Aug. 17, 2021

(51) Int. Cl. A21D 13/41; A21D 13/22; A21D 13/28

(52) U.S. Cl. CPC A21D 13/41; A21D 13/22; A21D 13/28

(57) ABSTRACT

A roll-type pizza may include a generally cylindrical spiral roll of an unbaked sheet of dough. A layer of olive oil may predominantly cover the first surface. A layer of red sauce may predominantly cover the layer of olive oil. A layer of mozzarella cheese may predominantly cover the layer of red sauce. A layer of chunk pepperoni may at least partially cover the layer of mozzarella cheese. The dough and layers of pizza ingredients may be rolled in a spiral manner to form an uncooked roll-type pizza. The roll-type pizza may be coating or dunked in butter. Parmesan cheese, garlic powder, garlic, salt, or oregano may be added on to the roll-type pizza. The roll-type pizza may be frozen, packaged, and stored for subsequent baking and serving.

### TECHNICAL FIELD

The embodiments generally relate to prepared pizzas.

### BACKGROUND

A new way of creating and enjoying pizza in small, bite size spiral arrangements is disclosed. Simple to cook and eat, the roll-type pizzas disclosed herein may be enjoyed as a snack or as a meal and may include all natural, preservative free ingredients. The convenient means of manufacturing, cooking, and enjoying roll-type pizzas overcomes known difficulties commonly associated with enjoying pizza. The disclosed roll-type pizzas may be easier to bake, travel with, and consume by reducing mess without sacrificing high quality flavor and ingredients.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A roll-type pizza may include a generally cylindrical spiral roll of an unbaked sheet of dough. A layer of olive oil may predominantly cover a first surface of the sheet of dough. A layer of red sauce may predominantly cover the layer of olive oil. A layer of mozzarella cheese may predominantly cover the layer of red sauce. A layer of chunk pepperoni may at least partially cover the layer of mozzarella cheese. The dough and layers of pizza ingredients may be rolled in a spiral manner to form an uncooked roll-type pizza. The roll-type pizza may be coating or dunked in butter. Parmesan cheese, garlic powder, garlic, salt, or oregano may be added on to the roll-type pizza. The roll-type pizza may be frozen, packaged, and stored for subsequent baking and serving.

A method of making a roll-type pizza may include mixing dough ingredients to produce a raw dough and proofing the raw dough for approximately forty minutes to form proofed dough. The method may include forming strips of proofed dough approximately four inches in width and extruding the strips of proofed dough to form at least one dough sheet including an upper surface opposite a lower surface and a first end opposite a second end. The method may further include forming a layered assembly including applying olive oil onto the upper surface; applying red sauce onto the olive oil; applying mozzarella cheese onto the red sauce; and applying pepperoni onto the mozzarella cheese. The method may further include rolling the layered assembly over itself into a roll-type pizza assembly; submerging the roll-type pizza assembly in a butter bath; removing the roll-type pizza assembly from the butter bath; and applying at least one of parmesan cheese, garlic powder, garlic, salt, or oregano to the roll-type pizza assembly. The roll-type pizza may be frozen, packaged, and stored for subsequent baking and serving.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of a roll-type pizza according to some variations described herein;

FIG. 2 illustrates a top view of a roll-type pizza according to some variations described herein; and

FIG. 3 illustrates a view of a portion of a method of making roll-type pizzas according to some variations described herein.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A roll-type pizza may include a generally cylindrical, spiral roll of at least one dough, olive oil, red sauce, mozzarella cheese, or pepperoni having a first surface opposite a second surface, and a first end opposite a second end. A layer of olive oil may predominantly cover the first surface; a layer of red sauce may predominantly covering the layer of olive oil; a layer of mozzarella cheese may predominantly cover the layer of red sauce; and a layer of pepperoni may at least partially cover the layer of mozzarella cheese. The layered assembly of dough, olive oil, red sauce, mozzarella, and pepperoni may be rolled to form a spiral roll and the first end may be secured to the second surface of the sheet of dough. The rolled assembly may form a single roll-type pizza or may be sliced perpendicular to a longitudinal axis of the rolled assembly to form multiple roll-type pizzas. At least one of parmesan cheese, garlic powder, garlic, salt, or oregano may be added to the roll-type pizza. The roll-type pizza may be about one and one-half inches in diameter and may be about one inch in height. The roll-type pizza may be subsequently refrigerated, frozen, or baked. In some variations, the roll-type pizza is packaged for resale, or frozen and packaged for resale and subsequent baking. The roll-type pizza may contain no preservatives, no artificial coloring, or no artificial flavoring.

The dough may be formed by combining flour, water, beer, dry active yeast, garlic powder, oregano, basil, sugar, salt, pepper, and olive oil. The dough ingredients may be mixed in a high-speed mixer system for about two to four minutes. After mixing, the dough may be allowed to proof for up to 40 minutes at room temperature. After proofing, the dough may then be knocked flat and cut into strips and fed into an extruder to start sheeting for the manufacturing of the roll-type pizzas.

The dough may be flattened into sheets about four inches wide. A plurality of layers of ingredients may applied to the dough to form a pre-rolled assembly. The dough may be fed down a conveyor and olive oil may be applied to a first surface of the sheet of dough. The olive oil may facilitate the attachment of the sheet of dough to itself when the roll-type pizza is furled. A layer of red sauce may be applied on to the layer of olive oil. The red sauce may include tomato sauce, red wine, cane sugar, parmesan, garlic powder, salt, pepper, basil, and oregano. A layer of mozzarella cheese may be applied on top of the layer of red sauce. The mozzarella cheese may be a whole milk product and not a part skim natural cheese. Pepperoni may be dispersed on the layer of mozzarella cheese. The pepperoni may be an all-beef, natural product.

The pre-rolled assembly may be rolled or furled over itself in a spiral arrangement and the first end of the sheet of dough may be attached to the sheet of dough such that the rolled assembly securely contains the layers of ingredients therein. The rolled assembly may be coated or dipped in butter and may subsequently be at least partially coated with additional ingredients and seasonings such as, but not limited to, parmesan, garlic, salt, or oregano.

The rolled assembly may be cut into smaller, individual roll-type pizzas prior to being refrigerated for approximately 4 to 6 hours. After refrigeration, the roll-type pizzas may be frozen. After freezing, the roll-type pizzas may be subsequently packaged and sealed.

The roll-type pizzas may be baked in a conventional oven at about 450 degrees Fahrenheit for about 12 minutes. Alternatively, roll-type pizzas may be cooked in a microwave.

FIG. 1 illustrates a perspective view of a roll-type pizza 10 including a sheet of dough 12 having a layer of olive oil (not shown) disposed thereon. A layer of red sauce 16 may be disposed on the layer of olive oil, and a layer of mozzarella cheese 18 may be disposed on the layer of red sauce 16. A plurality of pepperoni pieces 20, such as chunks, circles, or the like, may be disposed on the layer of mozzarella 18. the roll-type pizza may include a coating of butter 26 thereon in addition to various seasonings 24 such as, but not limited to parmesan cheese, garlic powder, garlic, salt, or oregano.

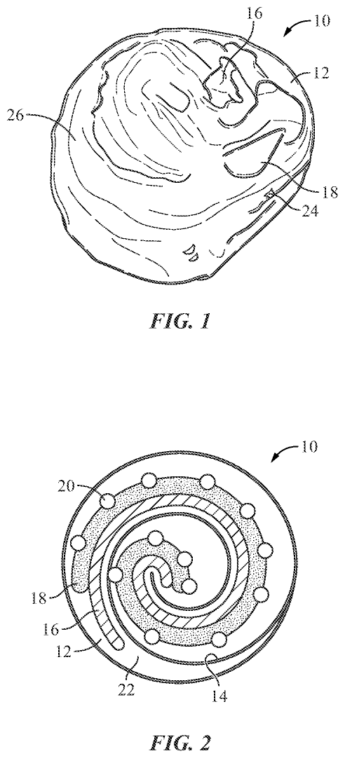

FIG. 2 illustrates a top view of a roll-type pizza 10 including a sheet of dough 12 having a first end 22. A layer of olive oil 14 may predominantly cover a first surface of the sheet of dough 12. A layer of red sauce 16 may be disposed on the layer of olive oil, and a layer of mozzarella cheese 18 may be disposed on the layer of red sauce 16. A plurality of pepperoni pieces 20, such as chunks, circles, or the like, may be disposed on the layer of mozzarella 18. According to some variations, the red sauce 16, mozzarella cheese 18, and pepperoni pieces 20, may not extend on to the first end 22 such that, when the assembly is rolled together, the first end 22 may attach to the body of the sheet of dough 12 such that the ingredients therein are secured.

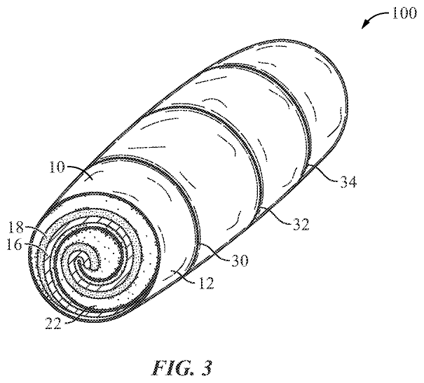

FIG. 3 illustrates a view of a portion of a method of making roll-type pizzas including a plurality of individual roll-type pizzas 10 cut from a primary roll 100. The primary roll 100 may include a sheet of dough 12 having a layer of olive oil (not shown) disposed thereon. A layer of red sauce 16 may be disposed on the layer of olive oil, and a layer of mozzarella cheese 18 may be disposed on the layer of red sauce 16. A plurality of pepperoni pieces (not shown), such as chunks, circles, or the like, may be disposed on the layer of mozzarella 18. The primary roll 100 may be sliced perpendicular to a longitudinal axis of the primary roll 100 as indicated by slices 30, 32, and 34. In this way, multiple roll-type pizzas 10 may be made simultaneously.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a roll-type pizza may include a generally cylindrical spiral roll of an unbaked sheet of dough having a first surface opposite a second surface, and a first end opposite a second end; a layer of olive oil predominantly covering the first surface; a layer of red sauce predominantly covering the layer of olive oil; a layer of mozzarella cheese predominantly covering the layer of red sauce; a layer of pepperoni at least partially covering the layer of mozzarella cheese; a coating predominantly covering the roll-type pizza, the coating including butter; and at least one of at least one of parmesan cheese, garlic powder, garlic, salt, or oregano on the roll-type pizza.

Variation 2 may include a roll-type pizza as in variation 1 wherein the roll-type pizza is frozen.

Variation 3 may include a roll-type pizza as in any of variations 1 through 2 wherein the roll-type pizza may be baked.

Variation 4 may include a roll-type pizza as in any of variations 1 through 3 wherein the roll-type pizza contains at least one of no preservatives, no artificial coloring, or no artificial flavoring.

Variation 5 may include a roll-type pizza as in any of variations 1 through 4 wherein the layer of red sauce, the layer of mozzarella cheese, and the layer of pepperoni predominantly cover the first surface except for a first portion near the first end of the at least one dough being predominantly covered only in olive oil.

Variation 6 may include a roll-type pizza as in any of variations 1 through 5 wherein the roll-type pizza includes the first portion of the at least one dough being predominantly covered only in olive oil and being secured to the second surface of the at least one dough to firmly form the roll-type pizza.

According to variation 7, a roll-type pizza may include a generally cylindrical, spiral roll of at least one dough, olive oil, red sauce, mozzarella cheese, or pepperoni having a first surface opposite a second surface, and a first end opposite a second end; a layer of olive oil predominantly covering the first surface; a layer of red sauce predominantly covering the layer of olive oil; a layer of mozzarella cheese predominantly covering the layer of red sauce; a layer of pepperoni at least partially covering the layer of mozzarella cheese; a coating predominantly covering the roll-type pizza, the coating including butter; and at least one of at least one of parmesan cheese, garlic powder, garlic, salt, or oregano on the roll-type pizza. The roll-type pizza may be about one and one-half inches in diameter and may be about one inch in height.

Variation 8 may include a roll-type pizza as in variation 7 wherein the roll-type pizza may be frozen.

Variation 9 may include a roll-type pizza as in any of variations 7 through 8 wherein the roll-type pizza may be baked.

Variation 10 may include a roll-type pizza as in any of variations 7 through 9 wherein the roll-type pizza contains at least one of no preservatives, no artificial coloring, or no artificial flavoring.

According to variation 11, a method of making a roll-type pizza may include mixing dough ingredients to produce a raw dough; proofing the raw dough for approximately forty minutes to form proofed dough; forming strips of proofed dough approximately four inches in width; and extruding the strips of proofed dough to form at least one dough sheet including an upper surface opposite a lower surface and a first end opposite a second end. The method may further include forming a layered assembly including applying olive oil onto the upper surface; applying red sauce onto the olive oil; applying mozzarella cheese onto the red sauce; and applying pepperoni onto the mozzarella cheese. The method may further include rolling the layered assembly over itself into a roll-type pizza assembly; submerging the roll-type pizza assembly in a butter bath; removing the roll-type pizza assembly from the butter bath; and applying at least one of parmesan cheese, garlic powder, garlic, salt, or oregano to the roll-type pizza assembly.

Variation 12 may include a method of making a roll-type pizza as in variation 11 further including refrigerating the plurality of roll-type pizzas for about four to about six hours.

Variation 13 may include a method of making a roll-type pizza as in any of variations 11 through 12 further including cutting the roll-type pizza assembly into a plurality of roll-type pizzas.

Variation 14 may include a method of making a roll-type pizza as in any of variations 11 through 13 further including freezing the plurality of roll-type pizzas.

Variation 15 may include a method of making a roll-type pizza as in any of variations 11 through 14 further including packaging the plurality of roll-type pizzas.

Variation 16 may include a method of making a roll-type pizza as in any of variations 11 through 15 further including baking the frozen plurality of roll-type pizzas at about 450° F. for about twelve minutes.

Variation 17 may include a method of making a roll-type pizza as in any of variations 11 through 16 wherein the roll-type pizza contains at least one of no preservatives, no artificial coloring, or no artificial flavoring.

Variation 18 may include a method of making a roll-type pizza as in any of variations 11 through 17 wherein applying olive oil onto the upper surface includes covering the upper surface from the first end to the second end.

Variation 19 may include a method of making a roll-type pizza as in any of variations 11 through 18 wherein applying red sauce, applying mozzarella cheese, and applying pepperoni occurs about one inch from the first end and extending to the second end of the at least one dough sheet to form a portion of the at least one dough being predominantly covered only in olive oil.

Variation 20 may include a method of making a roll-type pizza as in any of variations 11 through 19 wherein rolling the layered assembly over itself into a roll-type pizza assembly includes securing the portion of the at least one dough being predominantly covered only in olive oil to the second surface of the at least one dough to firmly form the roll-type pizza.

Many different embodiments have been disclosed herein, in connection with the above description and the drawing. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A roll-type pizza comprising:
a generally cylindrical spiral roll of an unbaked sheet of dough having a first surface opposite a second surface, and a first end opposite a second end;
a layer of olive oil predominantly covering the first surface;
a layer of red sauce predominantly covering the layer of olive oil;
a layer of mozzarella cheese predominantly covering the layer of red sauce;
a layer of pepperoni at least partially covering the layer of mozzarella cheese;
a coating predominantly covering the roll-type pizza, the coating comprising butter; and
at least one of at least one of parmesan cheese, garlic powder, garlic, salt, or oregano on the roll-type pizza.

2. A roll-type pizza as in claim 1 wherein the roll-type pizza is frozen.

3. A roll-type pizza as in claim 1 wherein the roll-type pizza is baked.

4. A roll-type pizza as in claim 1 wherein the roll-type pizza contains at least one of no preservatives, no artificial coloring, or no artificial flavoring.

5. A roll-type pizza as in claim 1 wherein the layer of red sauce, the layer of mozzarella cheese, and the layer of pepperoni predominantly cover the first surface with the exception of a first portion near the first end of the unbaked sheet of dough being predominantly covered only in olive oil.

6. A roll-type pizza as in claim 5 wherein the roll-type pizza comprises the first portion of the at least one dough being predominantly covered only in olive oil and being secured to the second surface of the unbaked sheet of dough to firmly form the roll-type pizza.

7. A roll-type pizza comprising:
a generally cylindrical, spiral roll of at least one dough, olive oil, red sauce, mozzarella cheese, or pepperoni having a first surface opposite a second surface, and a first end opposite a second end;
a layer of olive oil predominantly covering the first surface;
a layer of red sauce predominantly covering the layer of olive oil;
a layer of mozzarella cheese predominantly covering the layer of red sauce;
a layer of pepperoni at least partially covering the layer of mozzarella cheese;
a coating predominantly covering the roll-type pizza, the coating comprising butter;
at least one of at least one of parmesan cheese, garlic powder, garlic, salt, or oregano on the roll-type pizza; and
wherein the roll-type pizza is about one and one-half inches in diameter and is about one inch in height.

8. A roll-type pizza as in claim 7 wherein the roll-type pizza is frozen.

9. A roll-type pizza as in claim 7 wherein the roll-type pizza is baked.

10. A roll-type pizza as in claim 7 wherein the roll-type pizza contains at least one of no preservatives, no artificial coloring, or no artificial flavoring.

11. A method of making a roll-type pizza comprising:
mixing dough ingredients to produce a raw dough;
proofing the raw dough for approximately forty minutes to form proofed dough;
forming strips of proofed dough approximately four inches in width;
extruding the strips of proofed dough to form at least one dough sheet comprising an upper surface opposite a lower surface and a first end opposite a second end;
forming a layered assembly comprising:
applying olive oil onto the upper surface;
applying red sauce onto the olive oil;
applying mozzarella cheese onto the red sauce;
applying pepperoni onto the mozzarella cheese;
rolling the layered assembly over itself into a roll-type pizza assembly;
submerging the roll-type pizza assembly in a butter bath;
removing the roll-type pizza assembly from the butter bath; and
applying at least one of parmesan cheese, garlic powder, garlic, salt, or oregano to the roll-type pizza assembly.

12. A method of making a roll-type pizza as in claim 11 further comprising refrigerating the plurality of roll-type pizzas for about four to about six hours.

13. A method of making a roll-type pizza as in claim 11 further comprising cutting the roll-type pizza assembly into a plurality of roll-type pizzas.

14. A method of making a roll-type pizza as in claim 11 further comprising freezing the plurality of roll-type pizzas.

15. A method of making a roll-type pizza as in claim 11 further comprising packaging the plurality of roll-type pizzas.

16. A method of making a roll-type pizza as in claim 11 further comprising baking the frozen plurality of roll-type pizzas at about 450° F. for about twelve minutes.

17. A method of making a roll-type pizza as in claim 11 wherein the roll-type pizza contains at least one of no preservatives, no artificial coloring, or no artificial flavoring.

18. A method of making a roll-type pizza as in claim 11 wherein applying olive oil onto the upper surface includes covering the upper surface from the first end to the second end.

19. A method of making a roll-type pizza as in claim 11 wherein applying red sauce, applying mozzarella cheese, and applying pepperoni occurs about one inch from the first end and extending to the second end of the at least one dough sheet to form a portion of the at least one dough being predominantly covered only in olive oil.

20. A method of making a roll-type pizza as in claim 11 wherein rolling the layered assembly over itself into a roll-type pizza assembly includes securing the portion of the at least one dough being predominantly covered only in olive oil to the second surface of the at least one dough to firmly form the roll-type pizza.
